(19) United States
(12) Patent Application Publication
(10) Pub. No.: US 2015/0019301 A1
(43) Pub. Date: Jan. 15, 2015

(54) SYSTEM AND METHOD FOR CLOUD CAPABILITY ESTIMATION FOR USER APPLICATION IN BLACK-BOX ENVIRONMENTS USING BENCHMARK-BASED APPROXIMATION

(71) Applicant: Xerox Corporation, Norwalk, CT (US)

(72) Inventors: Gueyoung Jung, Rochester, NY (US); Naveen Sharma, Fairport, NY (US); Tridib Mukherjee, Bangalore (IN); Frank Michael Goetz, Fairport, NY (US)

(21) Appl. No.: 13/940,318

(22) Filed: Jul. 12, 2013

(51) Int. Cl. G06Q 10/06

(52) U.S. Cl. CPC G06Q 10/06393
USPC 705/7.39

(57) ABSTRACT

A system and method for providing cloud performance capability estimation and supporting recommender systems by simulating bottleneck and its migration for any given complex application in a cost-efficient way are provided. To do this, first, the system and method builds an abstract performance model for an application based on the resource usage pattern of the application in an in-house test-bed (i.e., a white-box environment). Second, it computes relative performance scores of many different cloud configurations given from black-boxed clouds using a cloud metering system. Third, it applies the collected performance scores into the abstract performance model to estimate performance capabilities and potential bottleneck situations of those cloud configurations. Finally, using the model, it can support recommender systems by providing performance estimates and simulations of bottlenecks and bottleneck migrations between resource sub-systems while new resources are added or replaced.

### BACKGROUND

The present disclosure relates to a method and system for cloud capability estimations with regard to deploying user software applications.

As cloud computing has become more popular, many cloud providers have offered their infrastructure services, and many small-to-mid-size businesses (SMBs) want to deploy their complex applications in the cloud. The first step for an SMB is making a decision on which cloud provider and cloud configurations offered by the cloud provider are right ones for their applications and how much of an advantage they can receive from their choice(s). Meanwhile, a factor for a cloud provider will be how to efficiently estimate performance capabilities of many other different competitors when a customer wants to deploy an application and then build a right one for the customer's application based on the estimates.

Such cloud capability estimation and decision supporting can be a big challenge, since most cloud providers in the market do not reveal their infrastructure configuration details, such as resource availability, the structure of physical servers, storages, and network switches, how to manage their virtual machines (VMs), etc. Rather, they only show a list of VM configurations and their prices. Additionally, cloud providers keep integrating new software and hardware artifacts into their cloud systems, and cloud users are overwhelmed by a number of such software and hardware technical options. Thus, it is reasonable to consider such clouds as black-boxes to the decision supporting processes.

In this situation, a cloud user may find a cloud configuration for an application by deploying it into each cloud configuration and measuring its performance capability. However, this would be very expensive and time consuming, since the cloud user will find a lot of different cloud configuration options, different applications and cloud configurations have different performance characteristics, and the procedure of the application deployment is typically complicated.

Cloud comparison services, such as “Cloud Harmony” (http://cloudharmony.com/), “Cloudy Metrics” (http://www.cloudymetrics.com/), and “Cloud Vertical” (https://www.cloudvertical.com/), can provide rudimentary comparisons of cloud infrastructures to potential cloud customers. In particular, they are simply providing VM types and their price comparison, or which VM has the fastest CPU, disk IO, or memory sub-system separately. This approach is not sufficient for cloud customers that try to deploy complex applications, such as multi-tier web site portals, image processing, and big-data analytics. This is because such resource sub-systems are usually inter-dependent in dealing with various workloads of those complex applications, some sub-systems can be bottlenecks for certain amount of loads, and bottlenecks are migrated between resource sub-systems as load changes.

Meanwhile, there have been attempts to develop theoretical performance models (e.g., queuing network models) that represent all cloud infrastructures for applications. However, the estimates computed by such models may not be accurate due to the diversity of cloud technologies and cloud-based applications that have different performance characteristics in different infrastructures.

Thus, there remains a need for a method and system that solves the aforementioned difficulties and others by providing cloud capability estimations with regard to deploying software applications.

### BRIEF DESCRIPTION

Described herein is a system and method for providing cloud performance capability estimation and simulating bottleneck and its migration for any given complex application in a cost-efficient way. To do this, first, the system and method builds an abstract performance model for an application based on the resource usage pattern of the application in an in-house test-bed (i.e., a white-box environment). Second, it computes relative performance scores of many different cloud configurations given from black-boxed clouds using a cloud metering system. Third, it applies the collected performance scores into the abstract performance model to estimate performance capabilities and potential bottleneck situations of those cloud configurations. Finally, using the model, it can simulate bottlenecks and bottleneck migrations between resource sub-systems while new resources are added or replaced.

In one embodiment, a computer-implemented method of estimating the performance capability of a cloud configuration for deploying a software application for a customer is provided. The method includes: characterizing the performance of a given workload in terms of resource usage pattern in a white-box test-bed; based on the resource usage pattern, estimating one or more performance capabilities to build an abstract performance model, wherein each of the performance capabilities represents a required performance capability of each resource sub-system to meet a target throughput; estimating one or more performance characteristics of one or more target clouds using a benchmark suite in terms of a set of capabilities, wherein each capability represents a specific configuration; using the capabilities and simulating for an optimal cloud configuration; and providing a comparison table using the simulation results to the customer.

In another embodiment, a system for estimating the performance capability of a cloud configuration for deploying a software application for a customer is provided. The system includes one or more processors configured to: characterize the performance of a given workload in terms of resource usage pattern in a white-box test-bed; based on the resource usage pattern, estimate one or more performance capabilities to build an abstract performance model, wherein each of the performance capabilities represents a required performance capability of each resource sub-system to meet a target throughput; estimate one or more performance characteristics of one or more target clouds using a benchmark suite in terms of a set of capabilities, wherein each capability represents a specific configuration; use the capabilities and simulating for an optimal cloud configuration; and provide a comparison table using the simulation results to the customer.

In yet another embodiment, a non-transitory computer-usable data carrier is provided. The non-transitory computer-usable data carrier stores instructions that, when executed by a computer, cause the computer to: characterize the performance of a given workload in terms of resource usage pattern in a white-box test-bed; based on the resource usage pattern, estimate one or more performance capabilities to build an abstract performance model, wherein each of the performance capabilities represents a required performance capability of each resource sub-system to meet a target throughput; estimate one or more performance characteristics of one or more target clouds using a benchmark suite in terms of a set of capabilities, wherein each capability represents a specific configuration; use the capabilities and simulating for an optimal cloud configuration; and provide a comparison table using the simulation results to the customer

With regard to any one or all of the preceding embodiments, the one or more target clouds comprise a single cloud or a composite cloud, the performance characteristics and capabilities may be used to compute one or more relative performance scores and the relative performance scores are applied to the abstract performance model, simulating various bottleneck and bottleneck migration situations may be performed by adding or replacing one or more virtual machines in a cloud configuration, and/or estimating one or more performance characteristics of one or more target clouds using a benchmark suite in terms of a set of capabilities may be performed using offline batch processes, with each batch process being scheduled periodically.

### BRIEF DESCRIPTION OF THE DRAWINGS

FIG. 1 is a screen shot of a performance comparison table;

FIG. 2 is a screen shot of a price comparison table;

FIG. 3 is a flowchart of an exemplary method of estimating the performance capability of a cloud configuration for deploying a software application for a customer;

FIG. 4 is schematic diagram of a system architecture suitable for implementing aspects of the exemplary embodiment;

FIG. 5 is a graph showing two example workloads and the relation between load and average throughput;

FIG. 6 is a graph showing three example average uses of resource sub-systems related to the performance of example read-only workload;

FIG. 7 is a graph showing three example average uses of resource sub-systems related to the performance of read-write mix workload;

FIG. 8 illustrates the memory performance score;

FIG. 9 illustrates the total CPU performance score;

FIG. 10 illustrates the system space CPU performance score; and

FIG. 11 illustrates the user space CPU performance score.

### DETAILED DESCRIPTION

In order to achieve cost-efficiency while keeping reasonable performance, large enterprises as well as SMBs have started to migrate to clouds by deploying their complex applications, such as web site portals and analytics, into cloud infrastructures. In this trend, the first question given to them is about which cloud providers and cloud configurations they have to choose to deploy their applications and then, how much they cost savings and performance can be achieved.

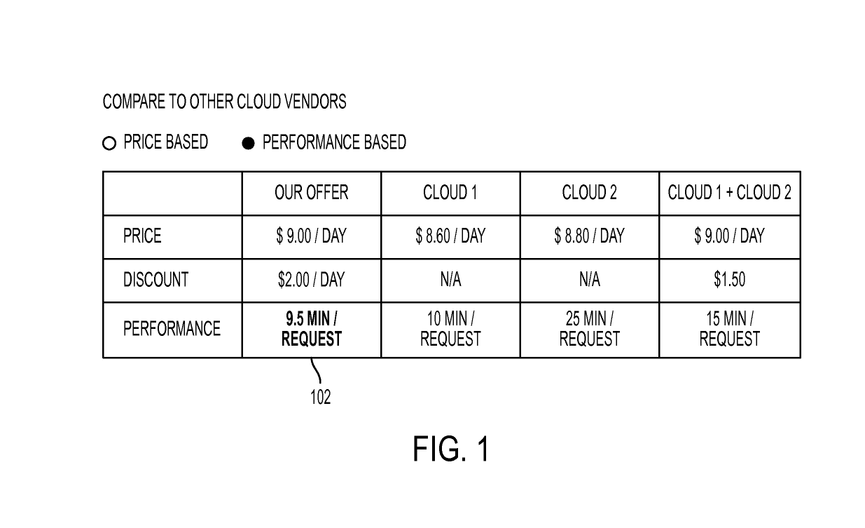

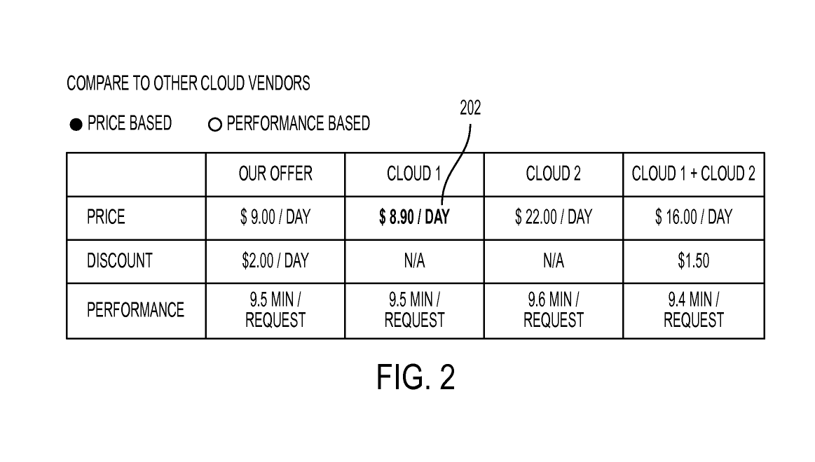

To provide a concrete cloud decision supporting service to customers, the exemplary system and method is configured to compare different cloud offerings made by other cloud providers for any given application and customer preferences. When a customer requests a comparison for their chosen specific application(s) and their preference(s), the decision supporting system displays one or more comparison tables, which may show price, discount, and/or performance for several cloud vendors, as depicted, for example, in the charts shown in FIG. 1 (a performance-based comparison) and in FIG. 2 (a price-based comparison).

For instance, FIG. 1 shows that when a customer wants to compare performances of different clouds based on the similar price offered by an in-house cloud, the exemplary system estimates the best performance that can be offered by each cloud vender with the price (i.e., Our Offer, Cloud 1, Cloud 2, Cloud 1+Cloud 2, etc.). Then, it shows which vendor can estimate the best performance among the cloud providers (e.g., box 102 in FIG. 1). Similarly, the exemplary decision supporting system may also estimate the best price among cloud providers with the given performance (i.e., Our Offer, Cloud 1, Cloud 2, and Cloud 1+Cloud 2), when the customer wants to compare prices of different clouds (e.g., box 202 in FIG. 2).

Various terms are used herein and there definitions are provided below. For example, as used herein, the term “cloud configuration” refers to software and/or hardware setup to deploy and run an application in a cloud environment. In a black-box environment, where the exemplary embodiment deals with, customers have very limited information about the target cloud. Hence, consider only available information such as the type of VM (e.g., small, medium, or large depending on its CPU, memory, and disk capacities) and its physical location only if the location information is available to customers. Note that in white-box environments, more information is available such as location, physical server type, infrastructure structure, methods of VM management, etc. The application can be deployed across multiple clouds (i.e., hybrid cloud and/or federated cloud).

The term “performance capability of cloud configuration” refers to the approximated maximum throughput of an application for a given application workload, when the application is deployed and run in a cloud configuration.

The term “resource usage pattern” refers to the correlation of resource usages (e.g., CPU, memory, disk IO, network bandwidth, context switch, etc.) to load change. In the exemplary method, the change rates of each resource sub-system are captured until the maximum capability is reached. It can approximately indicate the degree of contribution of each resource sub-system to the performance capability of a cloud configuration. It also implicitly indicates potential resource bottlenecks and migrations between resource sub-systems.

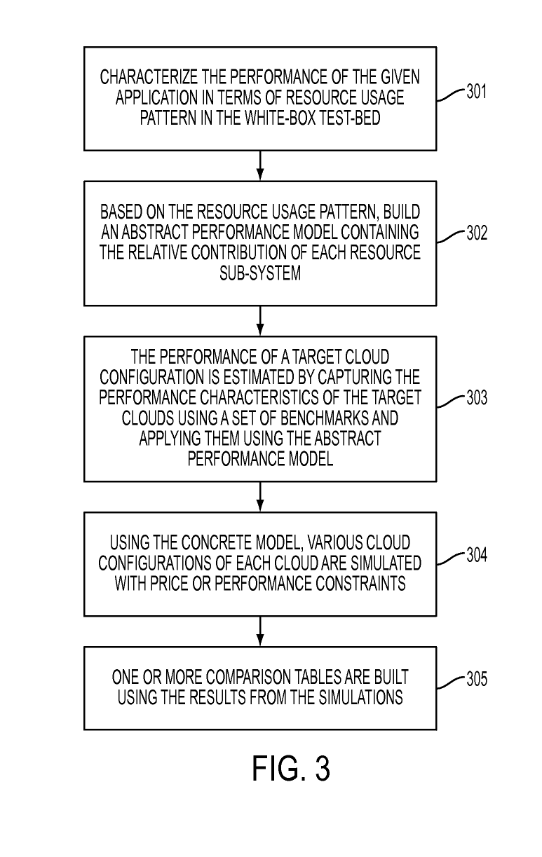

The exemplary method is set forth in the flowchart shown in FIG. 3. Thus, the exemplary method includes, for example, characterizing the performance of a given workload in terms of resource usage pattern in a white-box test-bed (301). Based on the resource usage pattern, the required performance capability of each resource sub-system (e.g., CPU, memory, disk I/O, network bandwidth, etc.) to meet a target throughput (302) is estimated separately. The performance characteristics of one or more target clouds (e.g., Cloud 1, Cloud 2, Cloud 1+Cloud 2, etc.) is estimated using a benchmark suite, referred herein as CloudMeter, and a set of capabilities is estimated, wherein each capability represents a specific configuration (e.g., a single VM) (303). With these capabilities, an optimal cloud configuration is searched (i.e., combined VMs to run the target workload) by a simulator until there are no further opportunities to minimize the price (304). Finally, a comparison table using the simulation results is created and displayed to the customer (305). Note that step 303 can be performed as offline batch processes, with each batch process being scheduled periodically, since those benchmarking results can be dynamically changed over time. It is also noted that the results of step 303 can be reused for other applications and workloads.

To achieve such comparisons, an important aspect is accurately estimating the performance capability of each cloud configuration for a given workload while exploring various different cloud configurations. Here, the performance capability of cloud configuration is defined as the approximated maximum throughput that can be achieved using a cloud configuration for the workload. To estimate performance capabilities of cloud configurations, the exemplary decision supporting system first builds an abstract performance model based on the resource usage pattern of the workload measured in an in-house test-bed (i.e., a white-box environment). Second, using CloudMeter, it computes relative performance scores of many different cloud configurations (i.e., black-box environments) against the in-house cloud. Finally, it applies the collected performance scores into the abstract performance model to estimate performance capabilities of those cloud configurations.

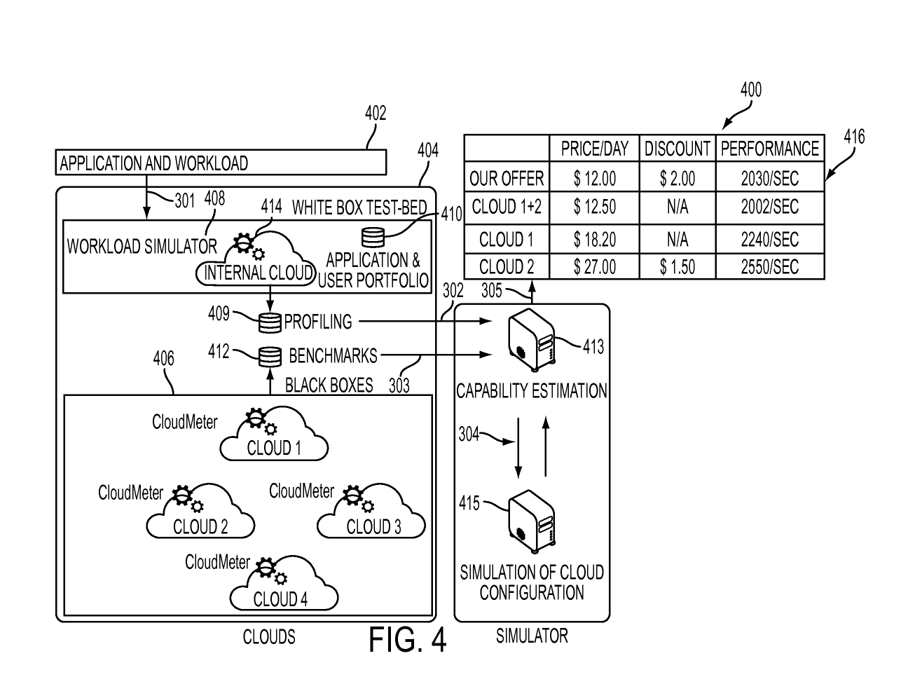

FIG. 4 shows a decision supporting system 400 that is suitable for implementing the exemplary method of performance capability estimation and simulation. First, for a given application and workload 402, the workload simulator 408 characterizes the application's performance (i.e., identify its resource usage pattern) by deploying the application into an in-house (or white-box) test-bed 404 and computes the correlation of resource usages to load change (step marked as “301” in FIGS. 3 and 4). The workload simulator 408 captures the usage change rates (i.e., slope) of each resource sub-system and the throughput change rate until the capability is reached, while load increases. These usage change rates can approximately indicate the degree of contribution of each resource sub-system to the performance capability. These computations may be accomplished by conducting measurements using the synthetic workload simulator 408 (step marked as “301” in FIGS. 3 and 4).

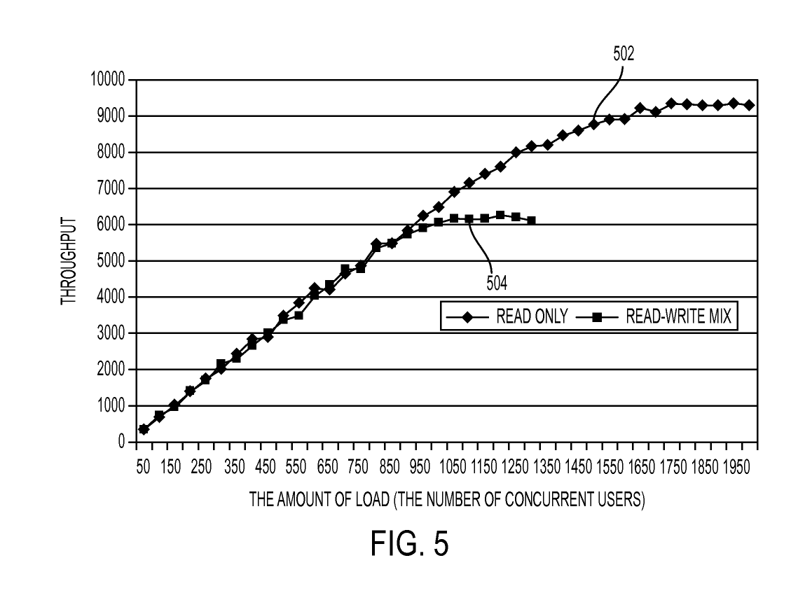

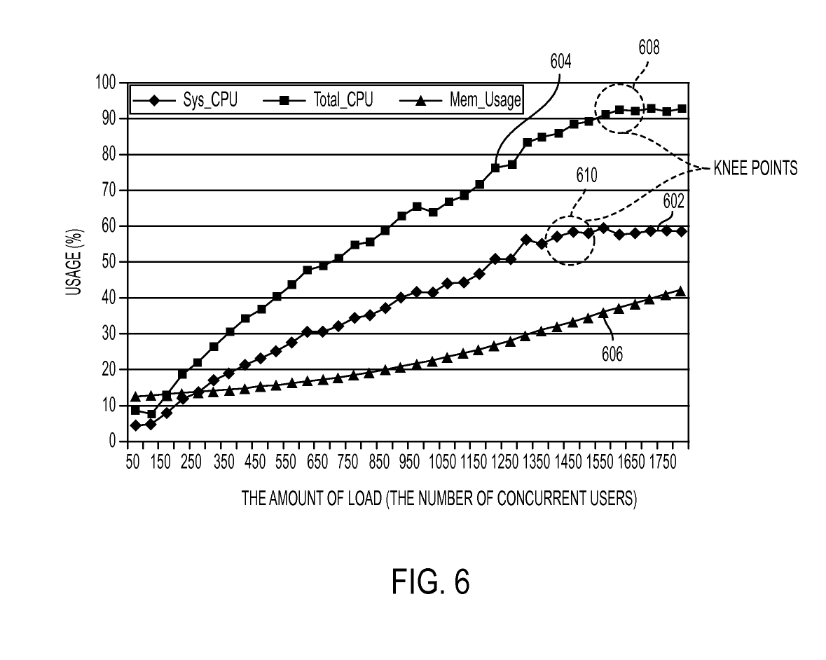

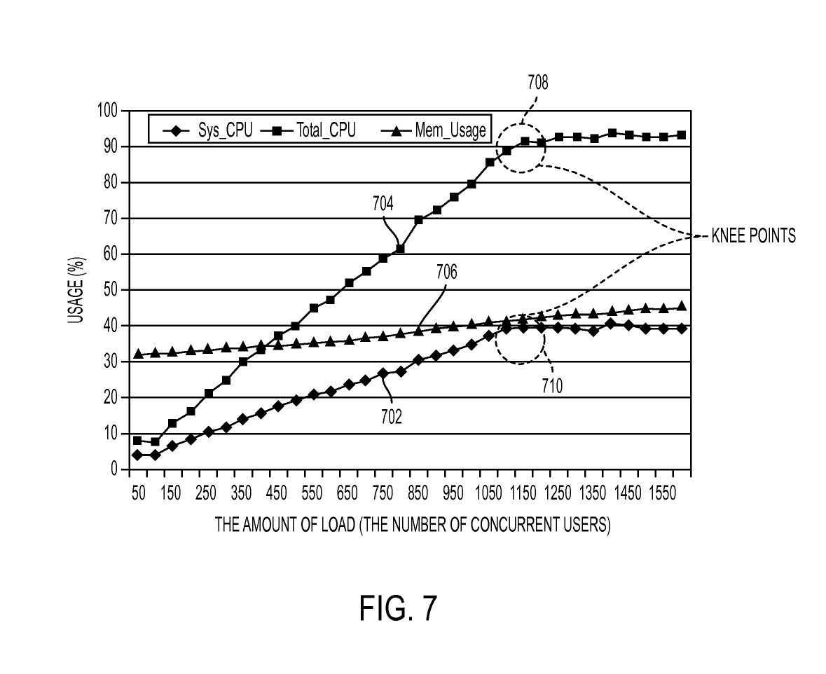

The workload simulator 408 generates synthetic loads with various data access patterns (e.g., the ratio of database write over read transactions and the ratio of business logic computation over read and write). If the historical workload is available in an application and user portfolio database 410, the workload simulator 408 can sort and re-play the workload to give systematic stress to the target application. The white-box test-bed 404 is generally capable of running any type of application, including CPU-intensive, memory-intensive, I/O intensive, and network intensive applications. To determine the resource usage pattern, the workload simulator 408 typically collects the change of throughput as the amount of load changes, as shown, for example, in FIG. 5, a graph showing two example workloads, read only 502 and read-write mix 504, and the relation between load and average throughput. Meanwhile, the workload simulator 408 also records the change of each resource sub-system as load changes. In this regard, FIG. 6 shows a graph showing three example average usages of resource sub-systems related to the performance of example read-only workload, i.e., system CPU 602, total CPU 604, and memory usage 606. And FIG. 7 shows a graph showing three example average usages of resource sub-systems related to the performance of read-write mix workload, i.e., system CPU 702, total CPU 704, and memory usage 706. The relationships between load and throughput and between load and resource usages are stored in a profiling database 409 (in FIG. 4) and later used to build the abstract performance model.

The collected resource usage pattern is stored in the application and user portfolio database 410 as well. Later, when a new application is given to the system, the system can reuse resource usage patterns by identifying the similar applications based on resource usage patterns. The white box test-bed is typically deployed into the internal cloud 414.

Based on the resource usage pattern, quantitative models for resource sub-systems are defined (step marked as “302” in FIGS. 3 and 4). As shown in FIG. 5, throughput increases until the performance capability reaches, and the point of the performance capability is determined by some resource sub-systems that consume the most of their available capacities (i.e., bottlenecked). Hence, the decision supporting system 400 and its components (i.e., the profiling database 409 and the capability estimator 413) define a quantitative model for each individual resource sub-system to identify its correlation to the performance capability. Specifically, for each resource sub-system j, a quantitative model can be defined as:

T=f(Uⱼ|(Cⱼ=c, ∃j∈R)Λ(C_{r′}=∞, ∀r′∈R))

where T is throughput, Uⱼ is the normalized usage rate over given capacity (i.e., Cⱼ=c) of a resource sub-system j, and r′ is each of all other resource sub-systems in R. Consider r′ as having unlimited capacities or capabilities to compute the correlation of only j to T.

To compute T using f, the system takes four steps. First, the decision supporting system 400 figures out the relation of load to the usage rate of the resource sub-system. The relation can be defined as a linear function or, generally, as a function that has a logarithmic curve for a resource sub-system j. Usage rates considered include the total CPU that consists of user and system CPU usages, cache, memory, disk I/O, and network usages. More specifically, the function can be as follows:

Uⱼ=s_{i,j}(αⱼ(2L−L^{p})+γⱼ) (1)

where L is the amount of load, p is used to minimize the square error (a linear function is a special case when p is 1), αⱼ is the rate of increase (e.g., a slop in a linear function), and γⱼ is an initial resource consumption. It is further noted that αⱼ, γⱼ, and p can be obtained by calibrating the function to fit into the actual curve. In this fitting, the portion of low load in the curve may be used, i.e., the portion before the knee of the curve (608, 610 in FIGS. 6 and 708, 710 in FIG. 7). Then, the system computes s_{i,j}, that is, the relative performance score of the cloud configuration i. This will be described in the next. In the white-box, s_{i,j} is 1.

Second, the relation of L to T is defined as,

T=β(2L−L^{q}) (2)

where β is the increase rate, and q is used to minimize the square error (a linear when q is 1). Similarly, β and q can be obtained by calibrating the function to fit into the actual curve.

Third, the capability is computed based on the correlation of j to L. A theoretical amount of load can be obtained when j reaches the full usage point using Eq. 1 (i.e., theoretically extending the curve beyond the knee point until Uⱼ is 1). Then, the obtained amount of load is applied to Eq. 2.

Finally, the capability of the cloud configuration can be represented as Tₘₐₓ=min(T₁, T₂, . . . , Tᵣ) where Tⱼ is the throughput computed from Eq. 2 for each j. In other words, Tⱼ is a maximum throughput when j is fully consumed while other resource subsystems are still available (because other resource sub-systems are considered to be unlimited). The capability is based on the fact that some resource sub-systems do not consume all of their available resources while only bottlenecked ones consume all of their resources.

Although the workload is same, the target cloud configuration i may have different performance characteristics. To complete the abstract performance model (i.e., Eq. 1), it is helpful to capture the performance characteristics of i in terms of relative performance score s_{i,j} for each resource subsystem j (step marked as “303” in FIG. 4). Using CloudMeter 406 in FIG. 5 or another benchmark suite, relative performance scores for the clouds (i.e., black boxes) are collected based on resource capability measurements. These scores can be reused for any different workload later. Generally, CloudMeter contains a set of micro-benchmark applications, such as Dhrystone, Whestone, System calls, and Context switch, that are integrated into UnixBench for CPU benchmarking, CacheBench for memory subsystem benchmarking, IOZone for disk I/O benchmarking, and or another network benchmark application. CloudMeter is useful when historical workload trace of an application in the target cloud is not available. Once it is available after the application is deployed, the application itself can be a benchmark of CloudMeter and then, the historical data can be used to compute s_{i,j} of a new workload that has similar performance characteristics. Benchmark results may be stored in a benchmarks database 412.

Using resource capability measurements, for example, s_{i,j} is computed as, s_{i,j}=bⱼ/b_{i,j}, where bⱼ represents the benchmarking measurement for j in the white-box cloud configuration, and b_{i,j} is one in the target cloud configuration i.

By applying s_{i,j} to Eq. 1, the performance capability of i can be obtained using a capability estimator 413. When dealing with the CPU sub-system, the system CPU usage should be considered separately in the total CPU usage, as shown in FIGS. 6 and 7, since the system CPU usage is related to context switch and system call used for interrupts, allocate/free memory, and communicating with file system that can be different among cloud configurations. Thus, extend s_{i,j} for the CPU sub-system as s_{i,cpu}=(s_{i,user}αᵤₛₑᵣ+s_{i,sys}α_{sys})/α_{cpu}, where αᵤₛₑᵣ is the increase rate of user CPU usage and α_{sys} is the increase rate of system CPU usage. Both rates are captured from the fitting model step in Eq. 1.

Using the concrete performance model and known pricing models, a simulator 415 simulates various cloud configurations to identify the optimal one (step marked as “304” in FIGS. 3 and 4) and then build the comparison table 416 based on price or performance constraint (step marked as “305” in FIGS. 3 and 4).

Based on the resource usage pattern including the bottleneck detection and its migration between resource sub-systems, the exemplary method and system can efficiently explore cloud configurations. There are various known heuristic algorithms to identify the optimal configuration including linear programming, integer programming, dynamic programming, or a graph (tree) search algorithm. However, they blindly explore the search space. When integrating the exemplary method with those algorithms, the search speed can be improved by providing a guideline for search.

Generally, it can be determined which resource sub-systems are bottlenecked at a certain amount of load from the resource usage pattern. Using the performance model, a simulation of how the bottleneck is potentially migrated to the other resource sub-system while increasing capacities and/or capabilities of those bottlenecked resources in the model beyond the amount of load can be developed. This iteration will keep going until the price or the performance constraint is met.

To evaluate the implementation of the recommender system, a 3-tier online auction application has been developed with Java servlet and running on an Apache Web server, a Tomcat application server, and a MySQL database server. A VM has been prepared in the white-box test-bed configured with 2 CPU cores and 4 GB memory, and running with an Ubuntu 10.2 operating system. This VM is deployed into an Intel blade with KVM virtualization. This VM is referred to as white.VM. Two other VMs were prepared as target cloud configurations to compare with white.VM. The first VM was configured with 1 CPU core and 2 GB memory and deployed into the same hardware (i.e., Intel blade) with the same virtualization (i.e., KVM). This one is referred to as black.VM1. For the second VM, a VM was purchased from Rackspace that has 4 CPU cores and 2 GB memory. This one is referred to as black.VM2. Note that the specific configuration of black.VM2 is usually unknown, but it has been determined that it runs over an AMD server with Xen virtualization.

Using white.VM in the test-bed, its throughput pattern was obtained as shown in FIG. 5, and resource usage pattern as shown in FIGS. 6 and 7. In FIGS. 6 and 7, usages of only 3 resource sub-systems are shown because these resource sub-systems mainly affect the application's throughput in all configurations.

The parameters and coefficients of abstract performance model that defines equation (1) have been captured as shown in Table 1 below. The results of the read-write mix workloads, which have the mix of read and write transactions from/to database, are shown because it has a more practical and complex workload than the read-only workload for this application.

TABLE 1
Coefficients and parameters of abstract performance models

| | | Square error | |
|---|---|---|---|
| Resource | Resource | of resource | Base resource |
| sub-system | increase rate, α | curve, p | consumption, b |
| CPU | 0.085 | 1 | 8 |
| User CPU | 0.053 | 1 | 5 |
| System CPU | 0.032 | 1 | 3 |
| Memory | 0.013 | 1 | 30 |

The throughput increase rate and square error of throughput curve for equation (2) have been captured as follows:

β=6.224 and q=1.1

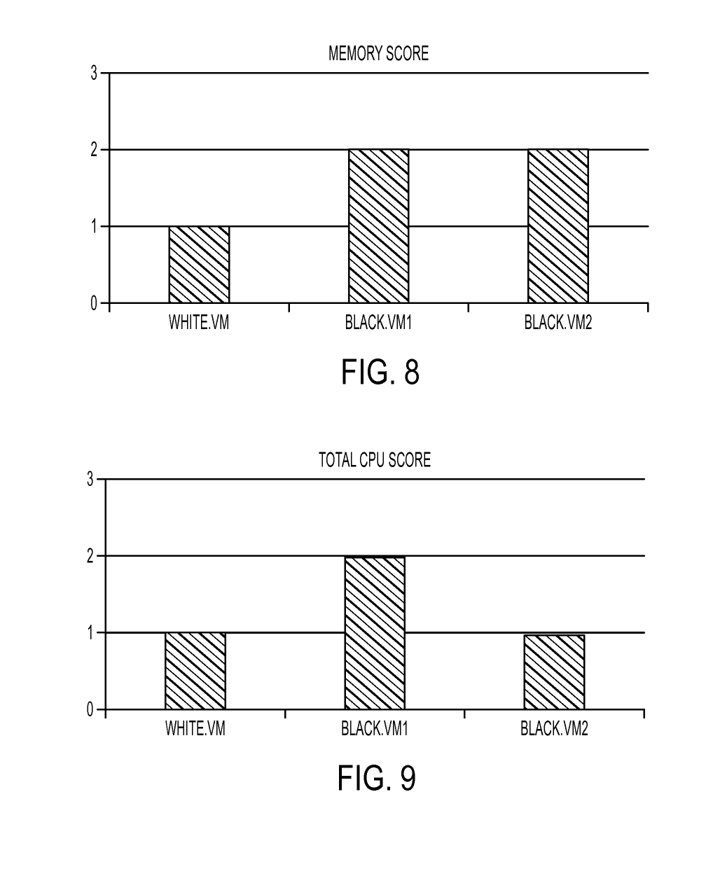

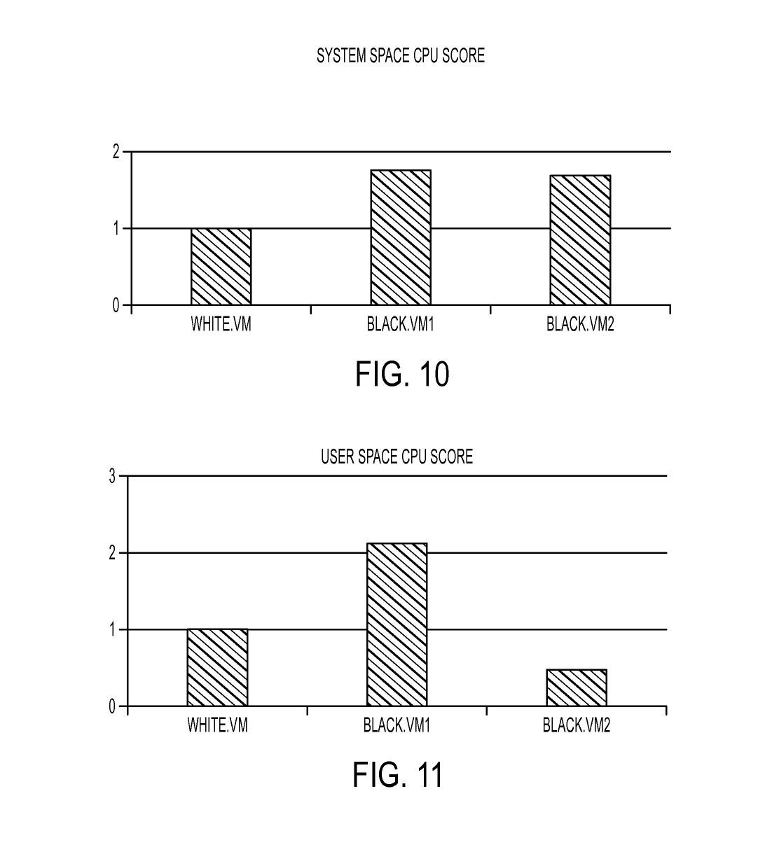

To compute the performance scores of black.VM1 and black.VM2, CloudMeter may be deployed into these VMs. The throughput of string manipulation for user space CPU score, the throughputs of context switch and system call for system space CPU score, and memory usage and IO for memory sub-system score may be measured. The results as computed using the above-mentioned equations are shown as performance scores of resource sub-systems (where lower is better) in FIGS. 9-12. In this regard, FIG. 8 shows the memory score. Note that the total CPU score of white.VM is very close to one of black.VM2 (FIG. 9) even though black.VM2 has more cores than white.VM. This is because the system space CPU score of white.VM is much lower than one of black.VM2 (FIG. 10) while the user space CPU score of white.VM is higher than one of black.VM2 (top left in FIG. 11).

By applying these scores to the abstract performance model, the estimated throughputs of black.VM1 and black.VM2 may be computed as shown in Table 2 below:

TABLE 2
Throughput estimates

| | Measured | | |
|---|---|---|---|
| | maximum | | |
| | throughput | T_{cpu} | Tₘₑₘ |
| white.VM | 6089 | | |
| black.VM1 | 3512 | 3294 | 3224 |
| black.VM2 | 6984 | 8052 | 7640 |

Memory sub-system is bottlenecked in black.VM1 because Tmem<Tcpu (but CPU sub-system can be bottlenecked because Tcpu is very close to Tmem in this case). Compared to the measured maximum throughput in black.VM1, the error rate is around 8%. For black.VM2, the memory sub-system is obviously bottlenecked (Tₘₑₘ is much less than T_{cpu}), and the error rate is around 9%. The accuracy for the read-only workload has been similar (around 10%).

In looking at the resource usage pattern in FIG. 7, it seems that CPU is bottlenecked, but it turns out that memory sub-system is bottlenecked in different configurations. Meanwhile, black.VM2 is more expensive than other similar configurations since it has more cores. The recommender system can recommend using some configuration like white.VM, which has enough memory, rather than some configuration like black.VM2, which has too many CPU cores. The bottleneck can be migrated between resource sub-systems (e.g., CPU and memory) as increasing resources (e.g., memory-intensive in black.VM1 vs. CPU-intensive in white.VM). Thus, the recommender system must accurately capture such resource usage pattern and bottleneck migrations, and estimate the performance when exploring clouds to recommend a reasonable cloud configuration for given application and its workload.

When a customer wants to deploy a complex application into the cloud, the exemplary embodiment offers various advantages, including the ones listed below.

First, the exemplary embodiment can build an abstract performance model for workload. The exemplary method characterizes the performance of given workload (i.e., data access and computation patterns), and encodes it to an abstract performance model that is used for estimating the throughput of any cloud configuration later.

Second, the exemplary embodiment can build a performance scoring model for cloud configuration. The exemplary embodiment characterizes the performance of the target cloud configuration in terms of relative performance scores for all resource sub-systems. It is configurable for a given application by integrating some benchmarks that have similar resource usage patterns with the application. Collected benchmark results can be reused for any different application later.

Third, the exemplary embodiment is a cost-efficient way to estimate cloud capability in black-box environments. The exemplary embodiment is configured to estimate the performance capability of any cloud configuration given from a black-box cloud environment. By applying those performance scores of a black-boxed cloud configuration into the abstract performance model, a performance capability approximation can be obtained. This system is less costly because it is not necessary to deploy the target application itself into all possible cloud configurations to measure performances.

Fourth, the exemplary embodiment provides simulation(s) of bottleneck migrations. The exemplary embodiment can simulate various cloud configurations. By figuring out bottleneck and bottleneck migration between resource sub-systems as load changes and new resources are added/replaced, the system can explore and simulate cloud configurations more efficiently than exploring blindly all possible cloud configurations.

Although the exemplary method is illustrated and described above in the form of a series of acts or events, it will be appreciated that the various methods or processes of the present disclosure are not limited by the illustrated ordering of such acts or events. In this regard, except as specifically provided hereinafter, some acts or events may occur in different order and/or concurrently with other acts or events apart from those illustrated and described herein. It is further noted that not all illustrated steps may be required to implement a process or method in accordance with the present disclosure, and one or more such acts may be combined. The illustrated methods and other methods of the disclosure may be implemented in hardware, software, or combinations thereof, in order to provide the control functionality described herein, and may be employed in any system including but not limited to the above illustrated recommender system, wherein the disclosure is not limited to the specific applications and embodiments illustrated and described herein.

The exemplary method may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 4 can be used to implement the method. It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method of estimating the performance capability of a cloud configuration for deploying a software application for a customer, the method comprising:
characterizing the performance of a given workload in terms of resource usage pattern in a white-box test-bed;
based on the resource usage pattern, estimating one or more performance capabilities to build an abstract performance model, wherein each of the performance capabilities represents a required performance capability of each resource sub-system to meet a target throughput;
estimating one or more performance characteristics of one or more target clouds using a benchmark suite in terms of a set of capabilities, wherein each capability represents a specific configuration;
using the capabilities and simulating for an optimal cloud configuration; and
providing a comparison table using the simulation results to the customer.

2. The method of claim 1, wherein the one or more target clouds comprise a single cloud or a composite cloud.

3. The method of claim 1, wherein the performance characteristics and capabilities are used to compute one or more relative performance scores and the relative performance scores are applied to the abstract performance model.

4. The method of claim 1, wherein simulating various bottleneck and bottleneck migration situations is performed by adding or replacing one or more virtual machines in a cloud configuration.

5. The method of claim 1, wherein estimating one or more performance characteristics of one or more target clouds using a benchmark suite in terms of a set of capabilities is performed using offline batch processes, with each batch process being scheduled periodically.

6. A system for estimating the performance capability of a cloud configuration for deploying a software application for a customer, the system comprising one or more processors configured to:
characterize the performance of a given workload in terms of resource usage pattern in a white-box test-bed;
based on the resource usage pattern, estimate one or more performance capabilities to build an abstract performance model, wherein each of the performance capabilities represents a required performance capability of each resource sub-system to meet a target throughput;
estimate one or more performance characteristics of one or more target clouds using a benchmark suite in terms of a set of capabilities, wherein each capability represents a specific configuration;
use the capabilities and simulating for an optimal cloud configuration; and
provide a comparison table using the simulation results to the customer.

7. The system of claim 6, wherein the one or more target clouds comprise a single cloud or a composite cloud.

8. The system of claim 6, wherein the performance characteristics and capabilities are used to compute one or more relative performance scores and the relative performance scores are applied to the abstract performance model.

9. The system of claim 6, wherein simulating various bottleneck and bottleneck migration situations is performed by adding or replacing one or more virtual machines in a cloud configuration.

10. The system of claim 6, wherein the one or more processors are further configured to estimate one or more performance characteristics of one or more target clouds using a benchmark suite in terms of a set of capabilities using offline batch processes, with each batch process being scheduled periodically.

11. A non-transitory computer-usable data carrier storing instructions that, when executed by a computer, cause the computer to:
characterize the performance of a given workload in terms of resource usage pattern in a white-box test-bed;
based on the resource usage pattern, estimate one or more performance capabilities to build an abstract performance model, wherein each of the performance capabilities represents a required performance capability of each resource sub-system to meet a target throughput;
estimate one or more performance characteristics of one or more target clouds using a benchmark suite in terms of a set of capabilities, wherein each capability represents a specific configuration;
use the capabilities and simulating for an optimal cloud configuration; and
provide a comparison table using the simulation results to the customer.

12. The non-transitory computer-usable data carrier of claim 11, wherein the one or more target clouds comprise a single cloud or a composite cloud.

13. The non-transitory computer-usable data carrier of claim 11, wherein the performance characteristics and capabilities are used to compute one or more relative performance scores and the relative performance scores are applied to the abstract performance model.

14. The non-transitory computer-usable data carrier of claim 11, wherein simulating various bottleneck and bottleneck migration situations is performed by adding or replacing one or more virtual machines in a cloud configuration.

15. The non-transitory computer-usable data carrier of claim 11, wherein the one or more processors are further configured to estimate one or more performance characteristics of one or more target clouds using a benchmark suite in terms of a set of capabilities using offline batch processes, with each batch process being scheduled periodically.
